(19) United States
(12) Patent Application Publication
(10) Pub. No.: US 2016/0380800 A1
(43) Pub. Date: Dec. 29, 2016

(54) Efficient Constellation

(71) Applicants: Ruoxi Wu, Houston, TX (US); Zhiming Wu, Houston, TX (US)

(72) Inventors: Ruoxi Wu, Houston, TX (US); Zhiming Wu, Houston, TX (US)

(21) Appl. No.: 14/753,546

(22) Filed: Jun. 29, 2015

(51) Int. Cl. H04L 27/34

(52) U.S. Cl. CPC H04L 27/3438

(57) ABSTRACT

Methods and apparatus for efficient mapping and demapping of constellation are described; the distance calculations are completely removed from the demapping process.

### CROSS-REFERENCE TO RELATED APPLICATIONS

### U.S. Patent Documents

2013/0329838 A1 EI-Hajjar et al. December 2013

### BACKGROUND OF THE RELATED ART

Constellation mapping is used to map the coding data into I-Q value at the transmitter. Constellation demapping is the reverse processing of the mapping at the receiver, converting the I-Q value to coding data. It takes a lot space to store I, Q values of the points in the constellation and to locate the closest the constellation point requires intensive processing. Many methods have been developed to reduce the distance calculations. By introducing I, Q sequence number in the mapping and demapping processing, the processing is made more efficient, and the distance calculations are completely removed from the demapping process.

### SUMMARY OF THE INVENTION

The invention presents a method of simplifying the OFDM constellation mapping and demapping processing, and a method of demapping processing without distance calculation.

### BRIEF DESCRIPTION OF THE DRAWINGS

FIG. 1 shows an exemplary QAM64 constellation.

FIG. 2 shows one zone of QAM64 constellation with QSN and ISN.

FIG. 3 shows the constellation mapping processing.

FIG. 4 shows one zone of rescaled QAM64 constellation with received point.

FIG. 5 shows the FEQ and constellation demapping modules of an OFDM decoder.

FIG. 6 shows the constellation demapping processing.

### DETAILED DESCRIPTION OF THE PREFERRED EMBODIMENT

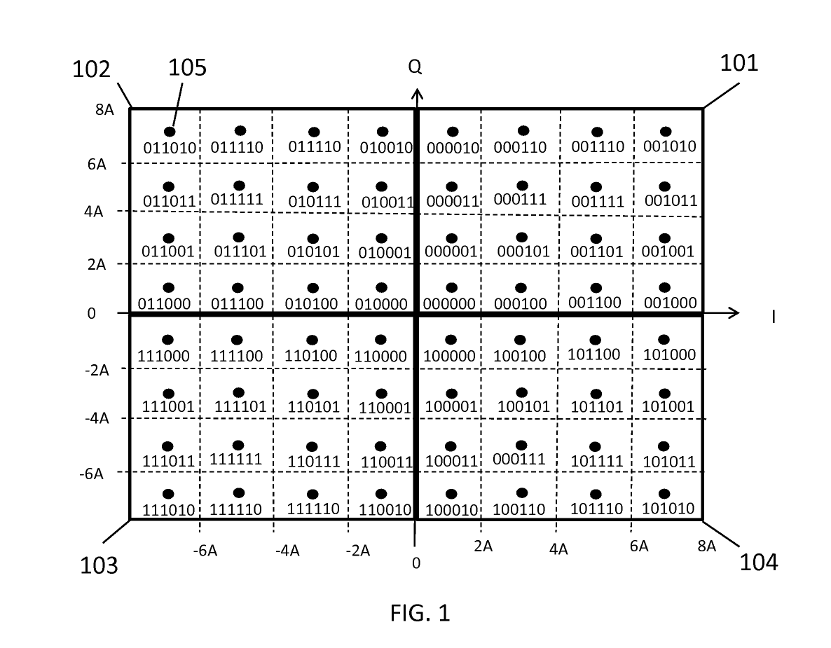

FIG. 1 shows an exemplary QAM64 constellation which has been given gray coded bit assignment to reduce the Bit Error Rate (BER). The real and imaginary axes are often called the in phase, or I-axis, and the quadrature, or Q-axis, respectively. The distance between two adjacent points is 2A.

The constellation is divided into four zones to simplify the processing. Two bits are used as the zone number; the two zone number bits can be placed anywhere in the code; the Most Significant Bit (MSB) bits (or left-most bits) are used as the zone number in this example.

The zone number of Zone-1 101 is 00, 01 for Zone-2 102, 11 for Zone-3 103, and 10 for Zone-4 104. The remaining bits for each point are the zone bits. The zone number of point 105 is 01 and zone bits are 1010, making the code of point 105 011010.

Zone bits of Zone-2 are flipped zone bits of Zone-1, and zone bits of Zone-3 and Zone-4 are flipped zone bits of Zone-2 and Zone-1, respectively.

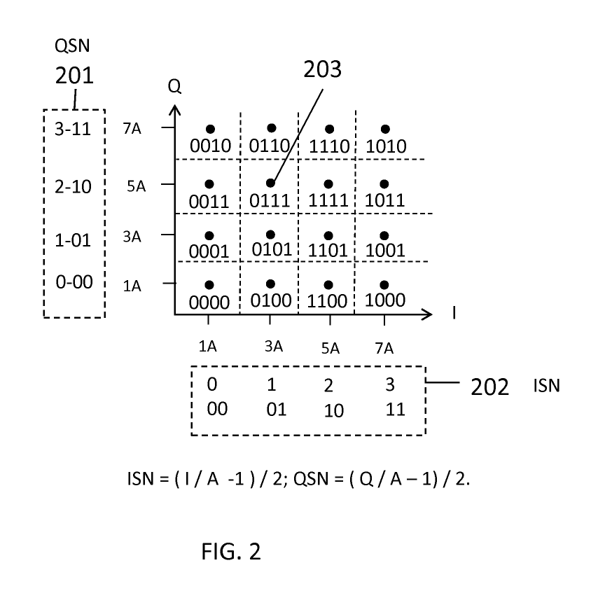

FIG. 2 shows Zone-1 of QAM64 constellation with Q Sequence Number (QSN) and I Sequence Number (ISN). ISN=(I/A−1)/2. QSN=(Q/A−1)/2. 201 is the QSN of all constellation points and 202 is the ISN values of all constellation points. QISN is the concatenation of QSN and ISN. At point 203, QSN=10, ISN=01, and QISN=1001. The zone bits can be calculated directly from QISN and vice versa. Look-Up Table(s) (LUT) for this conversion between zone bits and QISN can generated for mapping and demapping processing.

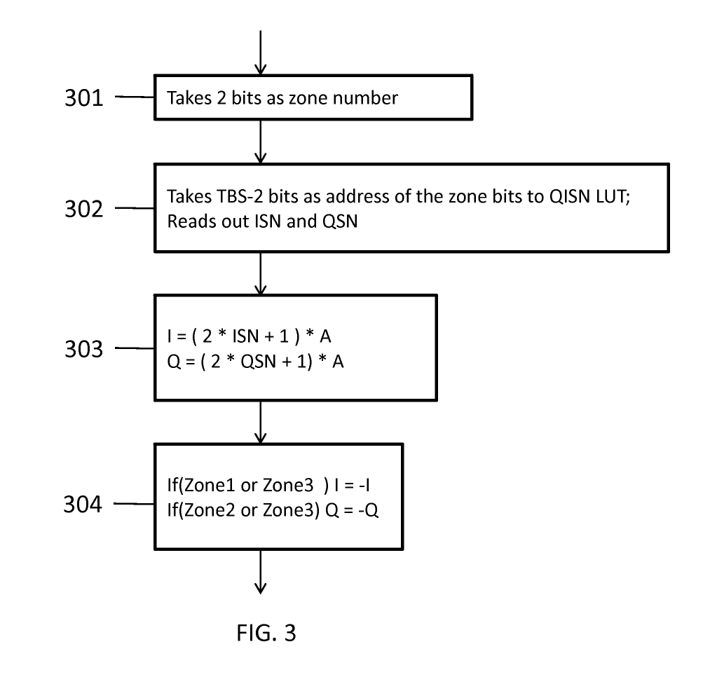

FIG. 3 shows the constellation mapping processing. Two bits are taken in 301 as the zone number. TBS stands for Total Bits of the tone. From the TBS, 2 bits are taken as the address of the QISN LUT in 302. The amplitude of I and Q are computed in 303, with I=(2*ISN+1)*A and Q=(2*QSN+1)*A. The polarity of I and Q is defined by the two zone number bits.

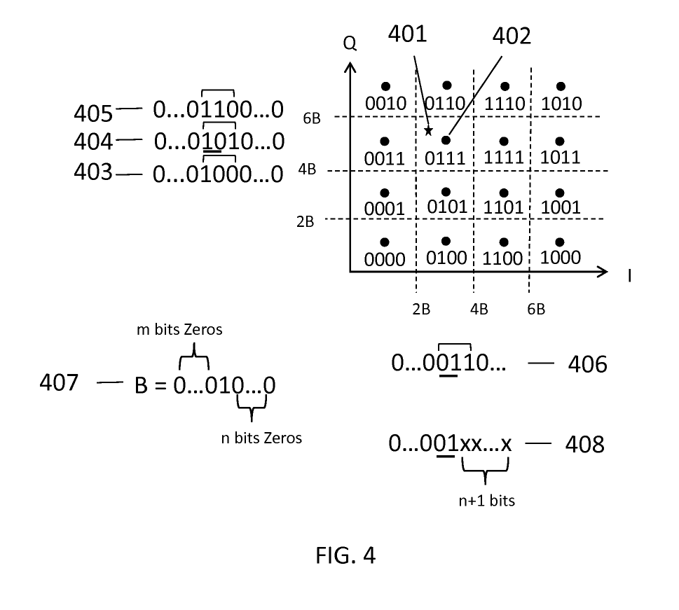

FIG. 4 shows Zone-1 of rescaled QAM64 constellation with received point. The distance of adjacent points on the constellation map is rescaled to 2B. B or 407 is a m+1+n bits number with only one bit's value as 1 and the remaining bits as zeros. B=0 . . . 010 . . . 0, m zeros at left and n zeros at right.

The closest constellation point of received data 401 is 402. The Q value 404 of point 402 is 0 . . . 01010 . . . 0, the low Q boundary 403 is 0 . . . 01000 . . . 0, and the upper Q boundary 405 is 0 . . . 01100 . . . 0. The Q value between the Q boundaries (4B to 6B) is 0 . . . 010xx . . . x; the two bits, n+2 and n+3 from the right is the QSN 10.

The I value 406 of point 402 is 0 . . . 00110 . . . 0. The value between its boundary 2B and 4B is 408 or 0 . . . 001xx . . . x. The two bits, n+2 and n+3 from the right is the ISN 01; x's can be either 0 or 1 as the value of the x's is not used.

The QISN is directly read from scaled I, Q value.

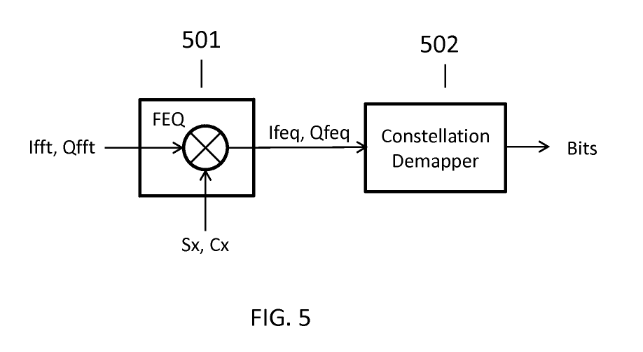

FIG. 5 shows the Frequency Equalizer (FEQ) and constellation demapping modules of an OFDM decoder. FEQ 501 does the phase rotation and amplitude attenuation (or amplification). Ifeq=Ifft*Cx−Qfft*Sx; Qfeq=Ifft*Sx+Qfft*Cx. FEQ 501 is mainly used for inverse channel transfer function processing in traditional OFDM decoding system. The constellation point rescaling processing is moved to FEQ to reduce the calculation. Three sets of Sx, Cx are used for different purposes; S0, C0 are used for FEQ training, S1,C1 are used for Channel Estimation (CES), and S2, C2 are used for constellation demapping.

With S0, C0, the gain of FEQ is 1 and the rotation is 0. With S1, C1, the amplitude of all training constellation points are calibrated to B. After CES training, S2, C2 are calculated from S1, C1 and the TBS for demapping. When TBS is an even number, S2=k*(POW(2,(TBS−2)/2+1)−1)*S1; C2=(Pow(2,(TBS−2)/2+1)−1)*C1. When TBS is an odd number, S2=k*(POW(2,(TBS−3)/2+1)−1)*S1*3/2; C2=(Pow(2,(TBS−3)/2+1)−1)*C1*3/2. The k in the above equation is the amplitude ratio of training symbol and the maximum I (or Q) of the data transportation in the transmitter. For the exemplary QAM64 constellation, S2=7*k*S1 and C2=7*k*C1. The maximum I and Q of the constellation is scaled to 7B, the Q of constellation point 402 to 5B, and the I of constellation point 402 to 3B.

The Constellation demapper 502 does the inverse processing of constellation mapping. It converts the constellation points into bit stream.

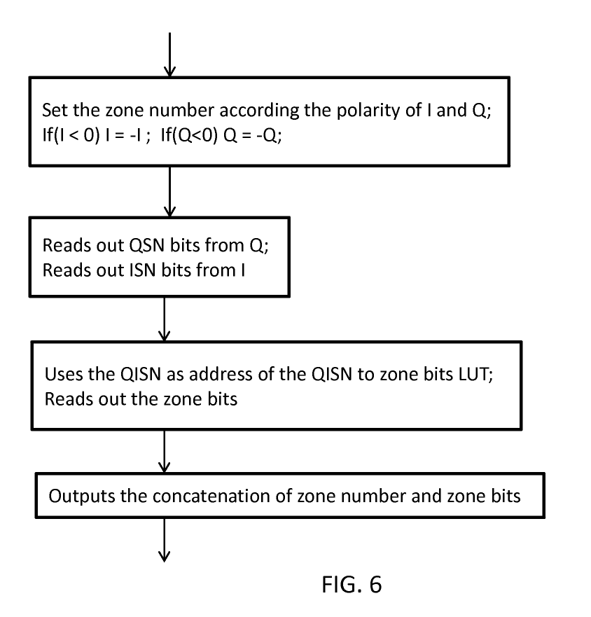

FIG. 6 shows the constellation demapping processing. The two bits of zone number are calculated from the polarity of the I and Q. The amplitude of I and Q are used to compute the zone bits. In the scaled I, Q, the ISN is certain bits at the middle of the I amplitude and the QSN is certain bits at the middle of the Q amplitude. Using the inverse processing of the mapping or a QISN to zone bits LUT, the zone bits can be found through the QISN. There's no distance calculation or comparison in the whole constellation demapping processing due to the rescaling process.

What is claimed is:

1. A method of constellation mapping, through:
a. dividing the constellation into four zones, two bits are used as zone number, and remaining bits are zone bits,
b. establishing the relationship between the zone bits to QISN,
c. calculating the amplitudes of Q and I from the QISN,
d. and setting the polarity of Q and I with zone number.

2. In the claim of method 1, wherein QISN is the concatenation of QSN and ISN, QSN the sequence number along the Q axis started from zero, and ISN is the sequence number along the I axis started from zero.

3. In the claim of method 1, wherein the amplitude of Q and I are calculated from ISN and QSN, I=(2*ISN+1)*A, Q=(2*QSN+1)*A with the distance between two adjacent points as 2A.

4. In the claim of method 1, the QISN is calculated from the zone bits with gray coding and finding the zone bits using the QISN Lookup Table (LUT) simplifies the processing.

5. A method of constellation demapping, through:
a. scaling the constellation points to get the QISN bits directly from Q and I value,
b. establishing relationship between QISN and zone bits,
c. and setting the zone number with polarity of Q and I.

6. In the claim of method 5 when Total Bits of the zone (TBS) is even, (TBS-2)/2 bits of the Q values between the point boundaries are the same and (TBS-2)/2 bits of I values between the constellation point boundaries are the same after scaling the Q and I values.

7. In the claim of method 5, when TBS is odd, (TBS−1)/2 bits of Q values between the point boundaries are the same and (TBS−1)/2 bits of I values between the constellation point boundaries are the same after the scaling.

8. In the claim of method 5, performing the scaling in FEQ reduces the calculations.

9. In the claim of method 5, converting QISN to zone bits is the inverse processing of zone bits to QISN in the constellation mapping, and a QISN to zone bits Lookup Table (LUT) simplifies the processing.
